(19) United States
(12) Patent Application Publication
(10) Pub. No.: US 2025/0105911 A1
(43) Pub. Date: Mar. 27, 2025

(54) COMPUTATION OF SATELLITE COMMUNICATION STRATEGIES

(71) Applicant: Cisco Technology, Inc., San Jose, CA (US)

(72) Inventors: Daniel Claude Holme, West Sussex (GB); Joel Abraham OBSTFELD, Bushey (GB); Louis Gwyn SAMUEL, Gloucestershire (GB)

(21) Appl. No.: 18/373,513

(22) Filed: Sep. 27, 2023

(51) Int. Cl. H04B 7/185

(52) U.S. Cl. CPC H04B 7/18513; H04B 7/18519

(57) ABSTRACT

According to one or more implementations of the disclosure, a device may determine a path of travel of the vehicle. The device may obtain telemetry data associated with the path of travel. The device may compute, based on the telemetry data, a communication strategy whereby the vehicle switches from using a first transceiver to communicate with a primary satellite network and a second transceiver to communicate with a secondary satellite network. The device may cause the vehicle to communicate according to the communication strategy.

### TECHNICAL FIELD

The present disclosure relates generally to satellite communications and more specifically to computation of satellite communication strategies.

### BACKGROUND

Satellite communication networks are utilized to communicate data with a variety of devices. For instance, multiple Low Earth Orbit (LEO) satellite constellations and others (e.g., Medium Earth Orbit (MEO), Geostationary (GEO), etc.) orbit the Earth providing data communication services to terrestrial (ground-, maritime- and airborne-based, etc.) endpoints. Satellite communication has progressed being the domain strictly of nation states. Now there are many different satellite communication networks owned and operated by different satellite network providers that may be commercial endeavors as well as nation states.

These vertically integrated constellations are currently utilized for global data communications to a range of fixed and mobile terrestrial endpoints including ground-based and airborne vehicles as well as maritime vessels. Services onboard a mobile endpoint may rely on data communications for operational purposes (e.g., navigation, control communications, etc.) and/or to provide data communications to passengers or systems being carried by the vehicle. For example, ‘freight in motion’ systems may utilize telemetry for cold-chain assurance needs to be provided. Today, such connected vehicles rely on a single LEO constellation (e.g., operated by a single satellite network provider) and/or require additional terrestrial communication systems (e.g., cellular in mobile cases, broadband in fixed cases, etc.) to be installed.

Resilient network coverage and consistent network performance are therefore critical qualities for a satellite communication network to offer to their network users. By their very nature, LEO satellite constellations are fast moving and condition sensitive systems operating in highly dynamic environments. Unfortunately, from the communications endpoint (network user) perspective, the conditions, network performance, operations state, real-time coverage data, and other factors influencing the ability of these systems to deliver resilient high-performance communication networks are presently a ‘black box’. There is little or no information provided to the communications endpoint about the performance and conditions of these satellite communication networks. Given this lack of visibility, classical methods for managing data communications path routing within these networks is not possible. Currently available routing protocols and active measurement protocols are simply not suitable for satellite network communications and there is no mechanism by which path selections can be intelligently orchestrated across multiple satellite constellations. Accordingly, satellite communication performance, resilience, and/or availability remains at best inconsistent and at worst insufficient for reliable, resilient data communications.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example network;

FIG. 2 illustrates an example network device/node;

FIG. 3 illustrates an example environment for endpoint communication with multiple satellite communication networks;

FIG. 4 illustrates an example of an architecture for computation of communication strategies between and endpoint and multiple satellite communication networks;

FIGS. 5A-5B illustrate examples of an environment for a digital twin approach to the computation of communication strategies between an endpoint and multiple satellite communication networks; and

FIG. 6 illustrates an example simplified procedure for the computation of communication strategies between an endpoint and multiple satellite communications networks, in accordance with one or more implementations described herein.

### DESCRIPTION OF EXAMPLE EMBODIMENTS

### Overview

According to one or more implementations of the disclosure, a device may determine a path of travel of a vehicle. The device may obtain telemetry data along the projected path of travel of the vehicle and compute, based on that telemetry data, a communication strategy whereby the vehicle switches from using a first transceiver to communicate with a primary satellite network and a second transceiver to communicate with a secondary satellite network. Then, the device may cause the vehicle to communicate according to the communication strategy.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications, and others. Other types of networks, such as field area networks (FANs), neighborhood area networks (NANs), personal area networks (PANs), etc. may also make up the components of any given computer network.

In various implementations, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or Powerline Communication networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Edge/fog computing is a distributed approach of cloud implementation that acts as an intermediate layer from local networks (e.g., IoT networks) to the cloud (e.g., centralized and/or shared resources, as will be understood by those skilled in the art). That is, generally, fog computing entails using devices at the network edge to provide application services, including computation, networking, and storage, to the local nodes in the network, in contrast to cloud-based approaches that rely on remote data centers/cloud environments for the services. To this end, a fog node is a functional node that is deployed close to fog endpoints to provide computing, storage, and networking resources and services. Multiple fog nodes organized or configured together form a fog system, to implement a particular solution. Fog nodes and fog systems can have the same or complementary capabilities, in various implementations. That is, each individual fog node does not have to implement the entire spectrum of capabilities. Instead, the fog capabilities may be distributed across multiple fog nodes and systems, which may collaborate to help each other to provide the desired services. In other words, a fog system can include any number of virtualized services and/or data stores that are spread across the distributed fog nodes. This may include a master-slave configuration, publish-subscribe configuration, or peer-to-peer configuration.

Low power and Lossy Networks (LLNs), e.g., certain sensor networks, may be used in a myriad of applications such as for “Smart Grid” and “Smart Cities.” A number of challenges in LLNs have been presented, such as:
1) Links are generally lossy, such that a Packet Delivery Rate/Ratio (PDR) can dramatically vary due to various sources of interferences, e.g., considerably affecting the bit error rate (BER);
2) Links are generally low bandwidth, such that control plane traffic must generally be bounded and negligible compared to the low rate data traffic;
3) There are a number of use cases that require specifying a set of link and node metrics, some of them being dynamic, thus requiring specific smoothing functions to avoid routing instability, considerably draining bandwidth and energy;
4) Constraint-routing may be required by some applications, e.g., to establish routing paths that will avoid non-encrypted links, nodes running low on energy, etc.;
5) Scale of the networks may become very large, e.g., on the order of several thousands to millions of nodes; and
6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

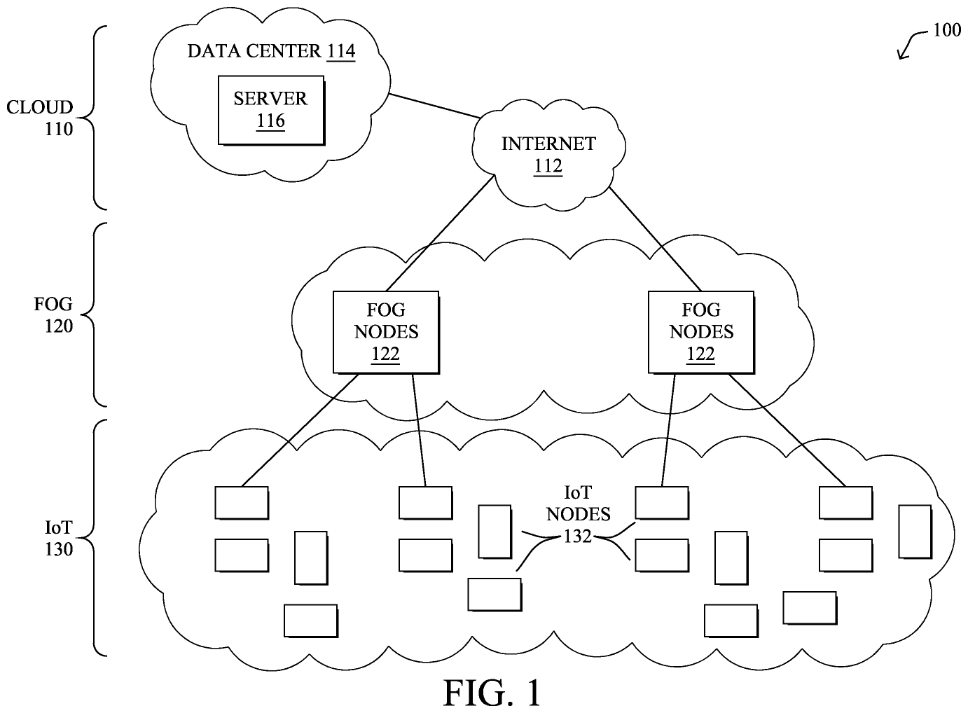

FIG. 1 is a schematic block diagram of an example simplified computer network 100 illustratively comprising nodes/devices at various levels of the network, interconnected by various methods of communication. For instance, the links may be wired links or shared media (e.g., wireless links, powerline communication links, etc.) where certain nodes, such as, e.g., routers, sensors, computers, etc., may be in communication with other devices, e.g., based on connectivity, distance, signal strength, current operational status, location, etc.

Specifically, as shown in the example network 100, three illustrative layers are shown, namely cloud layer 110, fog layer 120, and IoT device layer 130. Illustratively, the cloud layer 110 may comprise general connectivity via the Internet 112, and may contain one or more datacenters 114 with one or more centralized servers 116 or other devices, as will be appreciated by those skilled in the art. Within the fog layer 120, various fog nodes/devices 122 (e.g., with fog modules, described below) may execute various fog computing resources on network edge devices, as opposed to datacenter/cloud-based servers or on the endpoint nodes 132 themselves of the IoT device layer 130. For example, fog nodes/devices 122 may include edge routers and/or other networking devices that provide connectivity between cloud layer 110 and IoT device layer 130. Data packets (e.g., traffic and/or messages sent between the devices/nodes) may be exchanged among the nodes/devices of the computer network 100 using predefined network communication protocols such as certain known wired protocols, wireless protocols, powerline communication protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the network 100 is merely an example illustration that is not meant to limit the disclosure.

Data packets (e.g., traffic and/or messages) may be exchanged among the nodes/devices of the computer network 100 using predefined network communication protocols such as certain known wired protocols, wireless protocols (e.g., IEEE Std. 802.15.4, Wi-Fi, Bluetooth®, DECT-Ultra Low Energy, LoRa, etc.), powerline communication protocols, or other shared-media protocols where appropriate. In this context, a protocol consists of a set of rules defining how the nodes interact with each other.

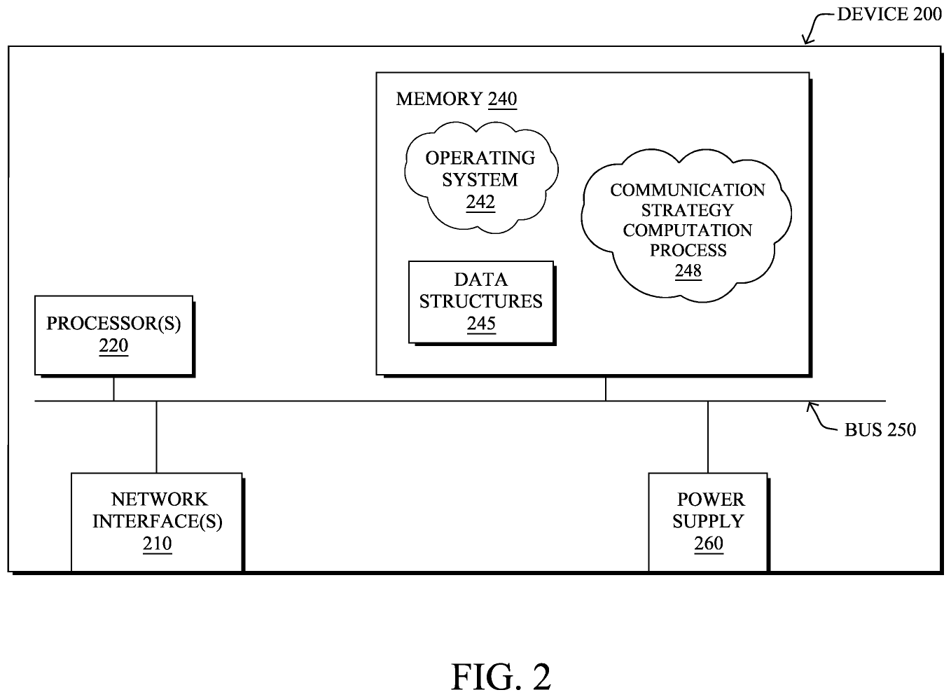

FIG. 2 is a schematic block diagram of an example node/device 200 (e.g., an apparatus) that may be used with one or more implementations described herein. As shown, device 200 may comprise one or more communication interfaces 210 (e.g., wired, wireless, etc.), at least one processor 220, and a memory 240 interconnected by a system bus 250, as well as a power supply 260 (e.g., battery, plug-in, etc.). In various implementations, node/device 200 may take the form of a networking device, such as a switch, router, a relay, a cluster head, or the like.

In various implementations, the node/device 200 may be an endpoint data communications router present on a vehicle such as an aircraft, a maritime vehicle, a ground vehicle, an autonomous or semi-autonomous vehicle, etc. Alternatively, or additionally, node/device 200 may be a local or remote computing device communicatively coupled to an endpoint router of a vehicle. In some instances, node/device may be part of and/or communicatively coupled to a navigation, communication, avionics, vehicle telemetry, radar, visual imaging, LIDAR, GPS, air-traffic controller, flight controller, autopilot, control surface controller, etc. systems and/or their controllers in a vehicle.

Communication interface(s) 210 include the mechanical, electrical, and signaling circuitry for communicating data over a communication link. To this end, communication interface(s) 210 may be configured to transmit and/or receive data using a variety of different communication protocols, such as Ethernet, TCP/IP, UDP, etc. Note that the node/device 200 may have multiple different types of communication interface(s) 210, e.g., wireless and wired/physical connections, and that the view herein is merely for illustration.

The memory 240 comprises a plurality of storage locations that are addressable by the processor(s) 220 and the communication interface(s) 210 for storing software programs and data structures associated with the implementations described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a communication strategy computation process 248, as detailed below.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

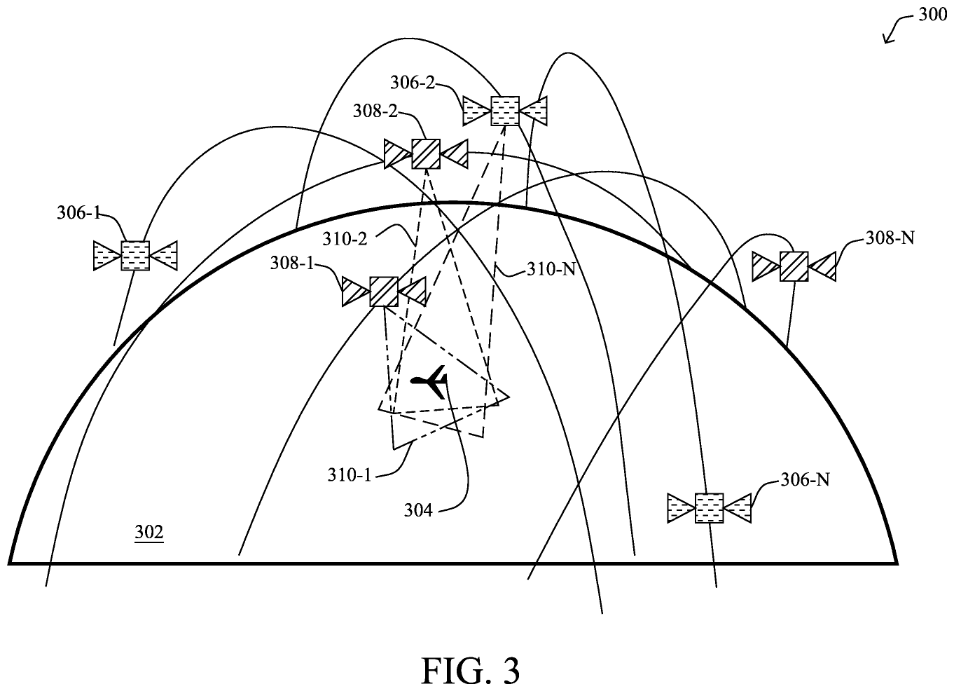

FIG. 3 illustrates an example environment 300 for endpoint communication with multiple satellite communication networks, in accordance with one or more implementations described herein. Environment 300 may include one or more satellites orbiting a planet (e.g., such as Earth 302) or some other object. Each satellite may include a data communications device which communicates with an Earth-based endpoint. This endpoint may be associated with, carried by, integrated in, etc. a vehicle 304. Therefore, references to endpoints, vehicles, and/or routers may be interpreted interchangeably with respect to location in some examples.

A satellite may communicate with an endpoint by sending and/or receiving a signal encoded with information. Each satellite may be a single satellite and/or operate within a constellation of satellites configured to communicate with communications equipment of vehicle 304. Satellites within the same constellation may communicate with one another by sending and/or receiving a signal encoded with information (e.g., along an intra-satellite communication network path). Satellites located within different constellations may also communicate with one another by sending and/or receiving a signal encoded with information (e.g., along an inter-satellite communication network path).

Environment 300 includes a primary satellite communication network 308 (e.g., made up of primary satellite communications network satellites 308-1 . . . 308-N) and a secondary satellite communication network 306 (e.g., made up of secondary satellite communications network satellites 306-1 . . . 306-N). The primary satellite communication network 308 may be a first constellation of satellites configured to collectively operate a first satellite communication network and that is owned and/or operated by a first satellite communications network provider.

The secondary satellite communication network 306 may be a second constellation of satellites, separate from the primary, and configured to collectively operate a second satellite communication network and that is owned and/or operated by a second satellite communications network provider. The secondary satellite communication network 306 may be a redundant, backup, and/or supplemental satellite communication network to that of the primary satellite communication network 308. It may, however, offer similar and/or supplementary data communication services to that of the primary, but through a different provider and/or network of satellites.

In various implementations, all or some of the primary satellite communications network satellites 308-1 . . . 308-N and/or all or some secondary satellite communications network satellites 306-1 . . . 306-N may be LEO satellites. As an LEO satellite, these satellites may orbit at an altitude less than about one-third of the radius of Earth. For example, they may travel in an orbit less than 2,000 kilometers (Km) above the surface of the Earth 302 (e.g., between six hundred and twelve hundred Km above Earth, etc.). In some instances, these satellites may orbit at a speed of approximately 7 Km/s-8 Km/s. The satellites may complete an orbit of Earth in less than 128 minutes (e.g., approximately every 90 minutes) orbiting Earth 302 multiple times per day (e.g., 11 or more orbits). In some specific examples, at a circular orbit altitude of 200 Km, the satellites may travel at 7.79 Km/s (28,000 Km/h); and at a 1,500 Km altitude, the satellites may travel at 7.12 Km/s (25,600 Km/h).

Environment 300 may include vehicle 304. Vehicle 304 may be an aircraft, a maritime vessel, a ground vehicle, an autonomous or semi-autonomous vehicle, etc. The vehicle 304 may include a data communications router that facilitates data communication with the primary satellite communication network 308 and/or secondary satellite communication network 306. In some instances, the data communications router may be an endpoint router with two or more communication interfaces (e.g., antenna, dishes, radios, transceivers, etc.) capable of conducting data communication with multiple satellite communications networks. Alternatively, or additionally, the data communications router may be a communication relay (e.g., cluster member, cluster head, etc.) for a group of vehicles, a group of sensors, ground control elements, etc.

The primary satellite communications network satellites 308-1 . . . 308-N and/or secondary satellite communications network satellites 306-1 . . . 306-N may send signals (e.g., data encoded satellite beams, etc.) encoded with information to vehicle 304. Likewise, vehicle 304 may send signals encoded with information to the satellites. In order for either of these communications to be received, a communicating satellite and vehicle 304 pair may need to be within communication range of one another and/or to any intervening relaying devices. To be in communication range, a satellite and vehicle 304 (or an associated relaying device) may need to be aligned within each other's signal delivery and/or reception path 310 (e.g., 310-1 . . . 310-N) and/or signal receiving area.

A signal delivery and/or reception path 310 may include the area within which a signal from vehicle 304 travels and/or within which a signal from a satellite may be detected and/or received. Therefore, in order for a communicating satellite and vehicle 304 pair to communicate with one another, the satellite may need to be in a position where its signal delivery and/or reception path 310 aligns with an area where the vehicle 304 is traveling and/or an area where a signal from that vehicle 304 is traveling.

At LEO satellite altitudes, only a very small portion of the Earth 302 may be visible to a particular satellite of a constellation at any given time. Further, due to the high velocity of such satellites, a location on Earth 302 may only be within communication range of the satellite for a short window of time (e.g., around ten minutes) during each fly-over of the location by that satellite. Therefore, a potential transmission window (pTxW) within which the satellite is in an appropriate position for sending and/or receiving signals to and/or from equipment mounted on a vehicle 304 within signal delivery and/or reception path 310 may have a short duration and occur at various periods throughout a day (e.g., once per aligning orbit, every 90-120 minutes, etc.). That is, a pTxW for communication between data communication equipment (e.g., antenna, dishes, radios, transceivers, etc.) mounted on vehicle 304 and a particular satellite may open when that satellite's signal delivery and/or reception path 310 aligns within the signal delivery and/or reception path of that data communications equipment during its fly-over pass and it may close when this alignment is lost.

As previously mentioned, each satellite communication network may be a constellation of satellites working together to provide uninterrupted communications. Therefore, when one satellite within a satellite communication network passes away from an area and out of alignment with data communication equipment of vehicle 304, datalinks may hand off information to the next satellite of that constellation that is coming within and/or is already positioned within communication range.

As noted above, currently multiple LEO constellations are in the process of being launched and/or are already operational in orbit around Earth 302. These LEO constellations provide services for global data communications to a range of fixed and mobile terrestrial endpoints (e.g., vehicles). Increasingly, these fixed and/or mobile terrestrial endpoints are reliant on reliable and resilient data communications provided by these constellations.

Meanwhile, the performance, operating conditions, operational state, reliability of coverage, etc. surrounding the operation of the LEO constellations remain completely obscured from data communication equipment of vehicle 304. Unfortunately, this operational black box surrounding the dynamic operations of these systems translates to a widespread unpredictable and/or unreliable data communications as a continuous plague on the operation of vehicles and other systems reliant on those capabilities.

Moreover, the mobile endpoints primarily rely on a single LEO constellation for their data communication needs with additional connectivity achieved through terrestrial means (e.g., cellular, broadband etc.)—which may not be viable or appropriate given the operating conditions within which the mobile endpoint may be present, for example, in a location where no cellular communications coverage can be provided. While connecting with additional satellite communication networks may provide some additional resilience, any type of a dual- or multi-connectivity approach to satellite communications for resilience, coverage, and/or capacity purposes cannot be served by this current paradigm. Afterall, there is no existing mechanism that provides comprehensive visibility sufficient to facilitate anticipation, identification, and/or avoidance of coverage gaps and performance problems in the satellite communication networks.

This deficiency is especially prominent in the context of highly mobile endpoints (e.g., capable of traveling hundreds to thousands of miles an hour). For example, establishing a resilient and reliable communication link between an aircraft rapidly traversing the stratosphere and an even faster satellite communication network constellation traversing the exosphere without awareness of all the relevant and rapidly evolving variables may be impossible. Afterall, both the endpoint and the satellite constellations are constantly and rapidly changing their positions relative to each other and relative to other objects, signals, conditions, etc. that can affect establishment and maintenance of a data communication connection. That is, given the hyper-dynamic nature of satellite constellation communication with highly mobile elements (e.g., satellites, vehicle mounted endpoints, etc.) that are in motion with respect to each other by variable velocities, are at very different altitudes (GEO/MEO/LEO), are subjected to different influential conditions, etc., classical methods for managing routing paths (e.g., using routing protocols and active measurement protocols) are not able to sufficient to effectively make path selections across a single satellite communication network constellation much less across multiple different satellite communication network constellations.

### Computation of Communication Strategies Among Satellite Communications Networks

In contrast, the techniques herein introduce a mechanism for optimizing utilization of multiple different satellite communication networks by a single mobile terrestrial endpoint (e.g., such as may be integrated to an aircraft, a maritime vessel, a ground vehicle, an autonomous or semi-autonomous vehicle, etc.). The techniques may be utilized to intelligently operate a resiliently connected endpoint by empowering it with visibility and/or knowledge of the underlying variables affecting the performance of each satellite communication network.

To tackle these challenges, a rich data set is employed to inform a system of elements and decisions to maximize the availability and efficacy of multi-satellite communication network constellation connectivity services to an endpoint in motion.

The techniques herein may facilitate computation of communication strategies between mobile endpoints and multiple different satellite communications networks that provide consistent, resilient data communications. With the resulting increased data communication performance and resilience, the operation and reliability of various implementations (such as high security vehicles with critical video feeds being streamed over the satellite connections; remotely piloted ground-based vehicles and maritime vessels with highly critical video and telemetry feeds to remote drivers/pilots; automated drones performing tasks with highly critical video feeds; automated ground-based vehicles and maritime vessels with some portion of mapping and control performed remotely; and/or variations thereof with 1:N piloting/driving services) can be improved.

Illustratively, the techniques described herein may be performed by hardware, software, and/or firmware, such as in accordance with communication strategy computation process 248, which may include computer executable instructions executed by the processor 220 (or independent processor of interfaces 210) to perform functions relating to the techniques described herein.

Specifically, according to various implementations, a method may include determining, by a device, a path of travel of a vehicle; obtaining, by the device, telemetry data associated with the path of travel; computing, by the device and based on the telemetry data, a communication strategy whereby the vehicle switches from using a first transceiver to communicate with a primary satellite network and a second transceiver to communicate with a secondary satellite network; and causing, by the device, the vehicle to communicate according to the communication strategy.

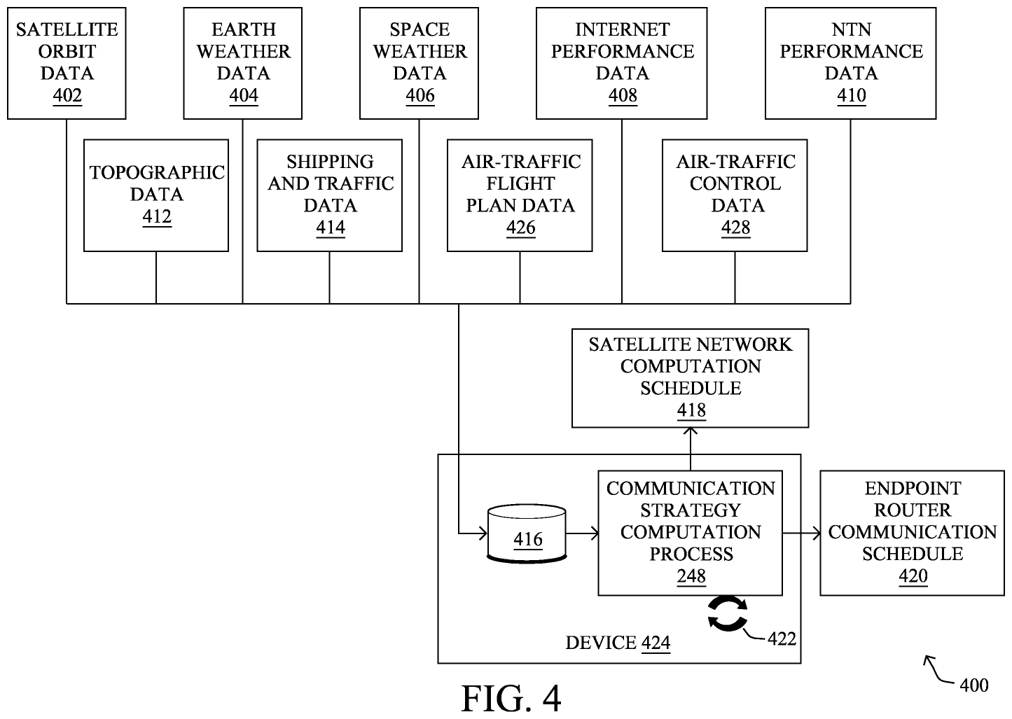

FIG. 4 illustrates an example of an architecture 400 for computation of communication strategies between an endpoint and multiple satellite communication networks. As noted above, while an individual satellite communication network constellation and user terminal system may optimize within its own closed system, conventional resiliently connected endpoints presently lack visibility of the underlying variables affecting the performance of each constellation. The existing approaches utilizing routing protocols, network probes, and/or application-awareness mechanisms for route selection and optimization in terrestrial networks are insufficient for route selection and optimization with mobile endpoints utilizing satellite communication networks.

For example, a satellite communication network's constellation may have gaps in its coverage that are dynamic and/or that the mobile endpoint has no way of knowing when such a gap will occur in advance. Moreover, external factors such as weather and network congestion may result in gaps in coverage within a specific constellation due to dynamic capacity and/or availability issues. Further, a highly dynamic spatial system of multiple unique satellite communication network constellations does not optimize for a multi-satellite communication network constellation connected endpoint. Furthermore, the geography and topography around a mobile endpoint may be changing with movement and/or may obscure connectivity to a satellite communications network.

However, architecture 400 may resolve these challenges and others by obtaining a rich data set characterizing the dynamic and the static conditions affecting satellite communication network performance and connectivity with an endpoint. This dataset may be utilized to compute a communications strategy that maximizes the availability and efficacy of multi-satellite communication network connectivity services. Moreover, given the dynamic nature of many of the conditions affecting satellite communication network performance and connectivity, architecture 400 may be configured to dynamically, periodically, and/or continuously collect real-time data on these conditions and/or to recalculate communication strategies based on the most up to date information. As such, in force communication strategies may be continuously updated to provide peak network performance and connectivity. In addition, these mechanisms may be used to enforce data sovereignty requirements as outlined below.

At the core of architecture 400 is communication strategy computation process 248, which may be executed by one or more devices (e.g., device 424). Device 424 may be configured to execute processes to compute and/or implement communication strategies among different satellite communication networks based on rich data sets that are collected in real-time and are continuously updated. These processes may facilitate a dynamic optimal path selection across the constellations of multiple satellite communication networks. As would be appreciated, these processes may be implemented on a singular device or in a distributed manner, in which case the combination of executing device can be viewed as their own singular device for purposes of executing communication strategy computation process 248.

Device 424 may be an endpoint data communications router of a vehicle such as an aircraft, a maritime vessel, a ground vehicle, an autonomous or semi-autonomous vehicle, etc. Alternatively, or additionally, device 424 may be a local or remote computing device communicatively coupled to an endpoint router of a vehicle. In some instances, device 424 may be part of and/or communicatively coupled to a navigation, communication, avionics, vehicle telemetry, radar, visual imaging, LIDAR, GPS, air-traffic controller, flight controller, autopilot, control surface controller, etc. systems and/or their controllers in a vehicle. Alternatively, or additionally, device 424 may a component of and/or communicatively coupled to a ground control station or other controller element (e.g., terrestrial-based, space-based, etc.) of one or more satellite communication networks and/or an air-traffic control component.

It should be understood that, while device 424 is shown outputting a satellite network communication schedule 418 and/or an endpoint router communication schedule 420, in some implementations this communication schedule may actually be consumed locally by the satellite communication network controller and/or the endpoint router (e.g., the device 424) executing the communication strategy computation process 248. In other implementations, the communication schedule may be communicated (e.g., pushed, pulled, broadcast, etc.) to a satellite communication network controller and/or endpoint router remote from but communicatively coupled to the device 424 executing the communication strategy computation process 248.

In some instances, each satellite communication network available for communication with an endpoint router may be assigned its own routing engine within executing the communication strategy computation process 248. In such instances, this dedicated and/or personalized routing engine may collect, compile, and/or consider relevant data regarding its capacity, weather, satellite movement, user endpoint (e.g., vehicle) movement, etc.

Communication strategy computation process 248 may utilize a rich data set in performing communication strategy computations. The data for this data set may be collected and compiled to a database 416 that is accessible to communication strategy computation process 248. The data may be collected, compiled, and/or maintained in database 416 in real time (e.g., collected, compiled, and/or maintained as soon as its created and/or acquired). The data may include data that is relatively static (e.g., data values that do not rapidly and/or regularly change in a non-predictable way) and/or data that is relatively dynamic (e.g., data values the oscillate rapidly and/or in a non-predictable way). As such, the data compiled in database 416 may be continuously, regularly, and/or periodically updated so that changes to the data values may be rapidly incorporated into satellite communication strategies.

In various implementations, the data set may include satellite orbit data 402. Satellite orbit data 402 may include data indicative of the location, orbit path, orientation, signal delivery and/or reception path, etc. of one or more satellites of a satellite communication network constellation at one or more moments in time. The satellite orbit data 402 may be collected by and/or from a satellite communication network provider in a programmatic fashion. This data may include dynamic changes to the space topology, pre-mapped known series of trajectories of the constellation elements, etc.

The data set may also include topographic data 412. Topographic data 412 may include data indicative of terrain, topography, structural features, geological features, etc. associated with the endpoint router and/or a vehicle carrying it. For example, the topographic data 412 may characterize these features at one or more locations along a route of the vehicle/endpoint router and/or at one or more moments in time during traversal of that route by the vehicle/endpoint router. The topographic data 412 may highlight topographic features which are likely to influence (e.g., block, retard, interfere with, etc.) data communication performance.

Satellite orbit data 402 and/or topographic data 412 may be relatively large data sets. For example, they may characterize satellite and/or vehicle/endpoint router positions across an entire planned path of the vehicle and/or period of time during which that path is traversed by the vehicle. Satellite orbit data 402 and/or topographic data 412 may be data sets that are mostly static in nature since the satellites and/or vehicles/endpoint router are typically configured to closely follow pre-defined paths on a predefined schedule.

The data set may include Earth weather data 404. Earth weather data 404 may refer to information related to current and/or forecasted weather conditions on Earth. This data typically includes details such as temperature, precipitation, wind speed and direction, humidity, atmospheric pressure, and other meteorological parameters that describe the state of the Earth's atmosphere. The Earth weather data 404 may include a timeseries forecast. Earth weather data 404 may be considered highly dynamic because it constantly changes over time due to weather patterns, atmospheric conditions, and other factors. This information may be crucial for various applications, including route planning, as it may help in understanding and predicting weather-related challenges and impacts on terrestrial and aerial transportation, among other things.

Further, the data set may include space weather data 406. Space weather data 406 may refer to information related to the conditions and phenomena that occur in space and can affect space-based assets and systems. Space weather data 406 typically includes data on solar activity, geomagnetic storms, cosmic rays, solar flares, and other space-related phenomena that can impact satellite communications, navigation systems, and spacecraft operations. The space weather data 406 may include a time series forecast. Space weather data 406 can be highly dynamic and can change rapidly based on solar and cosmic events. Monitoring and understanding space weather may be crucial for space-based applications, including satellite navigation, communication, and spacecraft operations, as it helps predict and mitigate potential disruptions caused by space weather events.

Furthermore, the data set may include Internet performance data 408. Internet performance data 408 may include data collected from active measurement protocols and/or external sources monitoring internet performance. Internet performance data 408 may refer to information related to the quality and efficiency of internet connectivity and communication. This data may include metrics and measurements that assess various aspects of internet performance, such as latency, bandwidth capacity, packet loss, jitter, throughput, network availability, etc. Internet performance data 408 may be dynamic and can vary based on factors such as network congestion, hardware conditions, and routing efficiency. Monitoring and analyzing the Internet performance data 408 may be essential for ensuring the quality of internet services, diagnosing connectivity issues, and optimizing network performance for various applications, including web browsing, streaming, online gaming, and business operations.

Moreover, the data set may include non-terrestrial network performance data (e.g., NTN performance data 410). NTN performance data 410 may be collected by and/or compiled from the satellite communication network providers or active measurement protocols. NTN performance data 410 may refer to data and metrics related to the performance of networks that are not based on Earth's terrestrial infrastructure. Non-Terrestrial Networks can include satellite networks, space-based communication systems, or any network that operates in space or in non-Earth environments. NTN performance data 410 may include metrics such as latency, bandwidth, signal strength, reliability, and other parameters that assess the effectiveness and quality of communication within these non-terrestrial networks. Like internet performance data 408, NTN performance data 410 may be similarly dynamic. Monitoring and analyzing the NTN performance data 410 may be critical for ensuring the reliability and efficiency of communication systems that rely on space-based or non-terrestrial networks, including satellite-based internet services, remote sensing, etc.

In addition, the data set may include shipping and traffic data 414. Shipping and traffic data 414 may refer to movement and conditions of vehicles, vessels, and other transportation systems, including the impact of this movement on the vehicle carrying the endpoint router. This may encompass shipping data involving information about the movement and status of vehicle transportation and/or details such as locations, routes, cargo status, port control information, arrival and departure times, and other relevant shipping information. Additionally, this may encompass traffic data pertaining to information related to route-based transportation. For example, shipping and traffic data 414 can include data on road conditions, traffic congestion, accidents, road closures, vehicle speeds, and other factors that affect the movement of terrestrial vehicles on roads, highways, and/or other routes. These types of data may be relevant because they can impact the performance and routing decisions of connected vehicles or devices. For instance, if a vehicle carrying the endpoint router is on a ship or a road, the status and conditions of shipping or traffic could influence route planning and connectivity decisions since they may influence the position of the endpoint router relative to a satellite's signal delivery and/or reception path in a given moment of time. This data can reflect dynamic conditions the understanding of which is vital for real-time adjustments and optimizations in multi-constellation path selection systems to ensure efficient and reliable communication for the vehicle and its connected devices.

The data set may include aircraft flight plan data 426. For example, where an endpoint is associated with data communication from an aircraft, the flight plan for that or other aircraft may be part of the data set. Aircraft flight plan data 426 may refer to the predefined and documented flight routes and information related to an aircraft's intended flight. These flight plans typically include details such as the planned departure and arrival airports, waypoints, airways, altitudes, estimated times of departure and arrival, and other relevant information regarding the aircraft's route. Aircraft flight plans may be a critical component of aviation operations and are typically filed in advance of a flight. They serve several purposes including: navigation (e.g., flight plans provide a structured route for the aircraft to follow, ensuring it safely navigates through airspace and reaches its destination), communication (e.g., air traffic control and other relevant authorities use flight plans to anticipate and manage air traffic, ensuring safe separation between aircraft), efficiency (e.g., flight plans help optimize fuel consumption and flight time by planning the most efficient routes), emergency preparedness (e.g., in the event of an emergency or deviation from the planned route, flight plans assist in search and rescue operations), etc. In the context of a multi-satellite communication network constellation path selection system, an aircraft's flight plan data may be one of the variables considered when making routing decisions. It may help ensure that satellite communication network constellation resources are used effectively to support the aircraft's communication needs during its flight.

Likewise, the data set may include air-traffic control data 428. Air-traffic control data 428 may refer to real-time information and data related to the management and monitoring of aircraft in flight within a specific airspace. This data may include various details about the position, velocity, and other relevant information about aircraft, and it is used by air traffic controllers to ensure safe and efficient air travel. Aspects of air-traffic control data 428 may include: real-time tracking (e.g., real-time information about the position and movement of aircraft within a particular airspace achieved through various technologies, including radar, GPS, and communication systems), aircraft identification (e.g., each aircraft may be identified by a unique code or call sign, allowing air traffic controllers to distinguish between different aircraft and monitor their progress), altitude and speed (e.g., information about an aircraft's altitude and speed, which is crucial for maintaining safe separation between aircraft and ensuring smooth traffic flow), flight plans (e.g., information about the flight plans filed by aircraft that helps controllers anticipate an aircraft's route and intentions), communication (e.g., communication between air traffic controllers and aircraft including voice communication and data transmission, ensuring that controllers can provide instructions and receive status updates from pilots), weather information (e.g., weather information, such as current weather conditions, turbulence reports, and weather forecasts, to help controllers make informed decisions), safety and conflict resolution (e.g., data used to maintain safe separation between aircraft and to resolve conflicts or potential issues), emergency situations (e.g., data about ongoing declared emergencies and/or data for coordinating responses, such as directing aircraft to suitable airports or facilitating emergency landings). Overall, air-traffic control data 428 may play a pivotal role in aviation safety and efficiency by enabling air traffic controllers to monitor and manage the movement of aircraft, maintain safe separation, and respond to various operational and safety-related situations in real-time. Moreover, in the context of a multi-satellite communication network constellation path selection system, this data may be one of the variables considered when making routing decisions. It may help ensure that satellite communication network constellation resources are used effectively to support the aircraft's communication needs during its flight by providing a real-time and holistic view of airspace activity and conditions.

Again, this data, in addition to associated metadata, may be compiled to database 416. There, it may be accessed and utilized by communication strategy computation process 248. Specifically, communication strategy computation process 248 may process and/or transform the data to develop an understanding of communication paths and their performance in a multi-satellite communication network constellation environment. These computations may be performed from an observational view and be used to make informed decisions beyond what an individual satellite communication network constellation could perform on its own. Specifically, communication strategy computation process 248 may utilize this data to compute a communication strategy whereby a vehicle/endpoint router switches from using a first transceiver to communicate with a primary satellite communication network and a second transceiver to communicate with a secondary satellite communication network. The communication strategy may be communicated to endpoint routers and/or satellite communication networks as communication schedules (e.g., a satellite network communication schedule 418, an endpoint router communication schedule 420, etc.) for implementation.

In various implementations, communication strategy computation process 248 may compute a communication strategy ahead of a vehicle/endpoint router's journey.

For example, for an aircraft in flight, a connectivity schedule can be planned ahead of the flight, with some variables of the computation being continuously monitored and/or their corresponding data values updated such that adjustments can be made to this schedule dynamically, if necessary.

Computing a communication strategy may include assessing satellite coverage for each timeslot in a journey for each connected satellite of a satellite communication network and/or a vehicle/endpoint router. This assessment may involve analysis of the data set to ascertain where each satellite and/or a vehicle/endpoint router will be at each time slot in the journey, whether there is alignment of their signal delivery and/or reception paths, conditions affecting data communication between aligned satellites and/or vehicle/endpoint routers, etc. For example, communication strategy computation process 248 may analyze flight paths of satellites of one or more satellite communication network constellations. The flight paths of satellite communication network constellations are typically fixed once individual satellites are in their final orbits. However, with adjustments to position, approaching orbit and de-orbiting actions, etc. the actual flight path may vary from a planned path. Therefore, the data sources for this assessment will have a stored state and be subject to regular updates on the satellites' positions.

Communication strategy computation process 248 may segment a map of a vehicle/endpoint router's journey into stages. At each of the stages, the vehicle/endpoint router can be allocated a set of temporal satellite connections as constellations make handovers dynamically. For example, a map of a flight of an aircraft endpoint can be broken into stages whereby which the aircraft can be allocated a set of temporal satellite connections as the different satellite communication network constellations make handovers dynamically, and uniquely.

Moreover, communication strategy computation process 248 may develop, disseminate, and/or cause to be implemented various communication strategies where the vehicle/endpoint router switches between different satellite communication network providers' constellations (e.g., a communication strategy whereby the vehicle switches from using a first transceiver to communicate with a primary satellite network and a second transceiver to communicate with a secondary satellite network). The ability to make routing decisions including a determination of which constellation among a plurality of different satellite communication network provider's constellations to utilize at any given time based on analysis of real-time data is particularly impactful where single satellite communication network provider's constellation may not be providing continuous global coverage. For example, a single satellite communication network provider's constellation may be incomplete due to orbital coverage dynamics, or perhaps because of issues in the inter-satellite connectivity causing a gap in coverage.

The computation of the communication strategy by the communication strategy computation process 248 may be based on analysis of the weather, network performance, and/or topography to make optimizations regarding which satellite and/or which satellite communication network to communicate with at any given segment of a vehicle/endpoint router's journey. For example, the assessment outlined above by communication strategy computation process 248 for satellite coverage for each timeslot in a journey (e.g., each stage of a flight path) may be further assessed against terrestrial weather up through the atmosphere that may influence communication within the assessed coverage areas. Poor weather situations could cause difficulty to reach a particular set of satellites at a particular point in space-time in a constellation, in which case alternatives (e.g., other satellite communication networks) can be assessed.

In addition, the assessment outlined above may be further assessed against network performance of the satellite communication network constellations with live connections to the vehicle/endpoint router (e.g., an aircraft's router). The performance of the network may include forwarding capability, capacity constraints, congestion, and/or other limiting factors. As previously noted, this data can be captured from the provider or using a method such as an active network probe. Poor network performance may be signaled by the satellite constellation or identified by the measuring agents. Poor network performance could cause difficulty to reach a particular set of satellites at a particular point in space-time in a constellation and/or to achieve necessary data communication performance thresholds. As a result, alternatives (e.g., other satellite communication networks) can be assessed when poor performance is detected and/or predicted on a primary satellite communication network.

Further, the assessment outlined above may be additionally assessed against topography data associated with the vehicle/endpoint router throughout its journey. For example, the vehicle/endpoint router may enter local terrain which brings visibility issues for line-of-sight connectivity to constellation satellites. Therefore, the regional topography will be considered in real time against the movement of the vehicle. It should be appreciated that, even in the case of aircraft endpoints, topographical data may play a role. For example, aircraft that operate at lower altitudes, including unmanned aerial vehicles (UAVs) and automated aerial vehicles, connected to multiple satellite communication network constellations, may be flying low enough that this local terrain brings visibility issues for line-of-sight connectivity to constellation satellites. In these types of applications, the regional topography may be considered in real time against the movement of the aircraft. Alternatives such as other satellite communication networks whose signal delivery and/or reception path might not be impacted by the topography may be assessed as switch over candidates.

Furthermore, the assessment outlined above by communication strategy computation process 248 for satellite coverage for each timeslot in a journey (e.g., each stage of a flight path) may be further assessed against other endpoint/vehicle traffic. For instance, using the regional flight plan schedule, the paths and requirements of other flights can be considered against the capacities of the connecting satellite communication network constellations and/or the fluid positions of all satellite and aircraft elements. Therefore, the connectivity strategy may be optimized among the different satellite communication network constellations with full considerations to other traffic, communication obligations, etc. that may impact connectivity.

In essence, communication strategy computation process 248 may utilize some and/or all of the data points from the data set, both static and/or dynamically updated, to compute a computation strategy as an optimal time series plan for constellation connectivity among different satellite communication networks corresponding to the known route or area in which the vehicle/endpoint router will be operating. This may involve orchestrating use of different communication interfaces, frequencies, communication protocols, hardware, etc. at different stages of a journey in order to communicate with the different satellite communication networks provided by different providers.

There may be multiple archetypes of how the resulting communication strategy (e.g., satellite network communication schedule 418, endpoint router communication schedule 420, etc.) is delivered and/or used during the journey of the vehicle/endpoint router (e.g., during a flight, etc.). For instance, satellite network communication schedule 418 and/or endpoint router communication schedule 420 may be pre-calculated as time series communication plans shortly in advance of the journey. The satellite network communication schedule 418 and/or endpoint router communication schedule 420 may include the primary steps in the time series communication plan and/or a time series of alternative communication paths.

In various implementations, the endpoint router communication schedule 420 may be stored at the endpoint router such that it can always operate against the time series plans. The endpoint router may utilize the endpoint router communication schedule 420 to configure its operation and/or its communication with one or more satellite communication networks. This information can also be used by routing systems onboard the vehicle to determine which interface to use for a particular application such as vehicle telemetry, radar, visual imagery, LIDAR, GPS, air-traffic controller, flight controller, autopilot, control surface controller, etc. etc. based on its own decision-making process. Updates to the endpoint router communication schedule 420 may be delivered with small incremental messages sent over the connection to the router to capture dynamic changes in weather patterns, network congestion, etc.

The endpoint router communication schedule 420 may be communicated (e.g., pushed) to the endpoint router and/or the satellite network communication schedule 418 may be communicated (e.g., pushed) to satellite communication network if required or requested by the constellation provider. This communication may be performed as a right-time communication delivering data at the right time as opposed to real-time. For example, data may be provided as updates delivered only when it needs to be consumed in order to avoid connectivity problems. This communication may be carried out in a lightweight, yet secure fashion. For example, an implementation may utilize machine-to-machine APIs over secure connections protected with transport layer security (TLS) or other alternatives.

When the endpoint router receives the endpoint router communication schedule 420, it can verify the connectivity services and install the current state in the onboard endpoint router's routing table for implementation of the communication strategy. The endpoint router may be configured to hold a sufficient time series dataset (e.g., in 2-6-hour blocks), along with a plan from the communication strategy computation process 248 for implementing updates as required.

In addition, the endpoint router communication schedule 420 may be communicated to and/or used to update an aircraft tracking database. For example, a private or public data repository may be updated with the communication strategy for an aircraft endpoint. In some instances, this aircraft tracking database may be a component of an air traffic control system. As such, this data may then become part of the air-traffic control data 428 which can be utilized in making updates to the communication strategy for the same aircraft endpoint and/or part of computing communication strategies for other aircraft endpoints.

In various implementations, communication strategy computation process 248 may continuously, periodically, regularly, according to a schedule, in response to updated data in database 416, in response to data value changes exceeding a threshold, etc. recompute 422 the communication strategy. Recomputing the communication strategy may include generating updated simulations and/or calculations as outlined above to take into account new and/or updated data in database 416. In this manner, the communication strategy may remain dynamic and adjust communication schedules to reflect real-time and/or predicted conditions and condition changes during a vehicle/endpoint router's journey. Therefore, communication strategy computation process 248 may produce, disseminate, and/or cause to be implemented updated satellite network and/or endpoint router communication schedules.

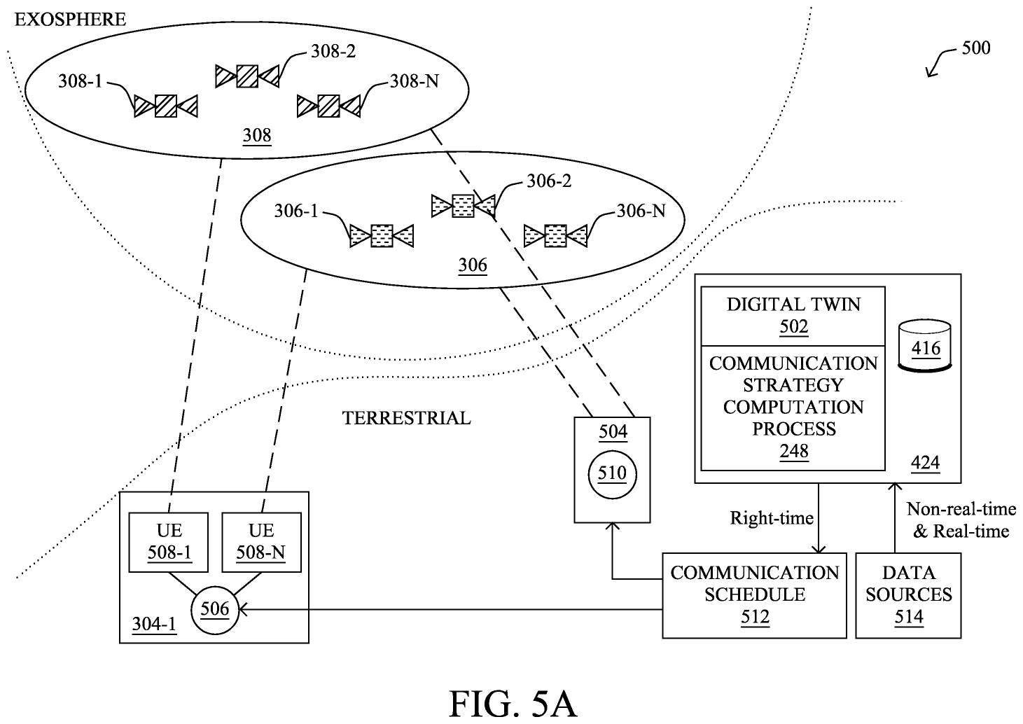

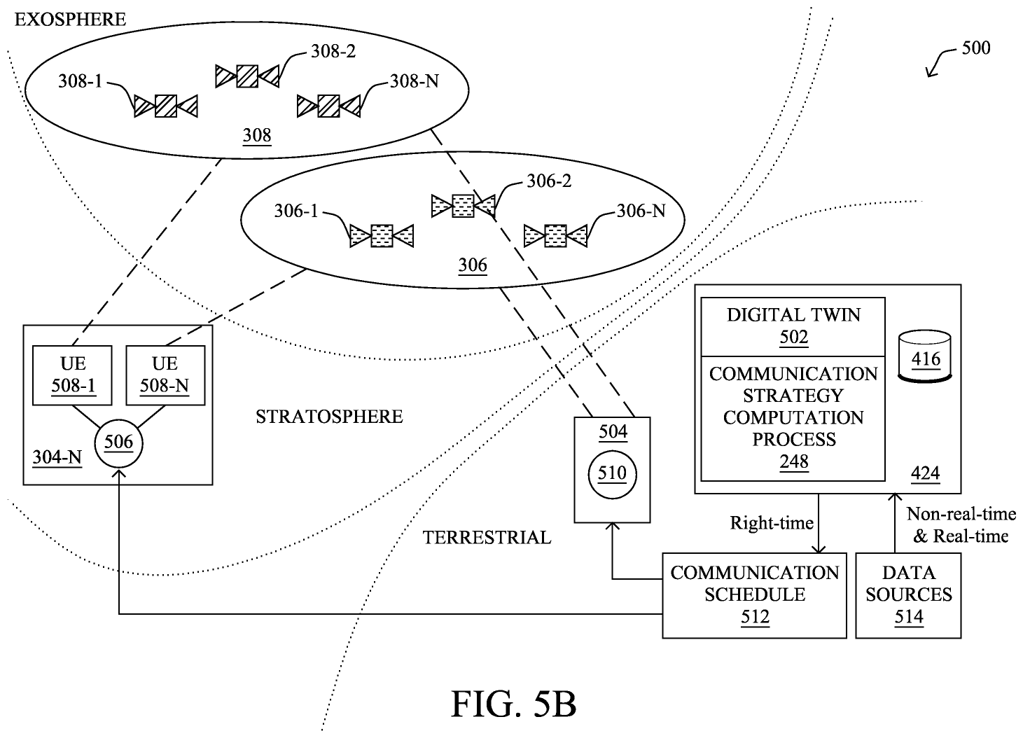

FIGS. 5A-5B illustrate examples of an environment 500 for a digital twin approach to the computation of communication strategies between an endpoint and multiple satellite communication networks, in accordance with one or more implementations described herein. Specifically, FIG. 5A illustrates the computation of communication strategies between a terrestrial vehicle endpoint 304-1 and multiple satellite communication networks orbiting in the exosphere while FIG. 5B illustrates the computation of communication strategies between an airborne vehicle endpoint 304-N traversing airspace within the stratosphere and the multiple satellite communication networks orbiting in the exosphere. Due to the huge amount of different data sources 514 (real- and non-real-time) involved and the highly volatile spatial model calculations required, the communication strategy computation process 248 may use a digital-twin operating mode for communication strategy computation and delivery.

This may include generating and maintaining a digital twin 502 simulation or model of the complex communication relationships of a vehicle/endpoint router and/or satellite communication networks and the conditions affecting their communication with one another. This digital twin 502 may be a simulation or model that continuously incorporates changing dynamic data inputs of the system to refine and/or update a communication strategy applicable to the system.

For example, after an initial communication strategy has been sent to the endpoint router 506 of vehicle 304 (e.g., 304-1 . . . 304-N) and/or to a controller 510 of a ground control or landing or landing segment 504, communication strategy computation process 248 may continually update digital twin 502 by continuously simulating changes to the system. These simulations may be triggered in response to changes in the dataset stored in database 416. In some instances, the simulations may be triggered by changes in the dataset that exceed a predetermined threshold.

These simulations can tune elements within the control of the communication strategy computation process 248, such as considering paths of other vehicles utilizing multiple satellite data communication network constellations together, tuning paths against weather scenarios simulated in advance, convergence of vehicles into a zone connected sub-optimally to one constellation, etc. When communication strategy computation process 248 determines that the update to digital twin 502 necessitates a change to its initial communication strategy, it can cause an updated communication schedule 512 that incorporates those changes to be communicated (e.g., pushed, etc.) to an endpoint router 506 where it can be applied to cause user endpoints 508 (e.g., 508-1 . . . 508-N) to selectively communicate with different satellite communication networks as specified in the updated communication schedule 512.

For example, endpoint router 506 may be configured to communicate via a first user endpoint 508-1 with satellites of a primary satellite communication network 308 (e.g., primary satellite communication network satellites 308-1 . . . 308-N) by an initial communication schedule. However, updated space and/or Earth weather data may be added to database 416 and/or utilized to update digital twin 502 simulations, causing communication strategy computation process 248 to determine that this connection is now an inferior option to a connection with secondary satellite communication network 306 (e.g., secondary satellite communication network satellites 306-1 . . . 306-N). As such, communication strategy computation process 248 may cause an updated communication schedule 512 to be communicated to endpoint router 506. The updated communication schedule 512 may be applied to cause the endpoint router 506 to disregard its initial communication configuration and instead to communicate via a second user endpoint 508-N with satellites of secondary satellite communication network 306. This may be delivered as a right-time update to a communication schedule, preparing the endpoint router 506 to adjust for forthcoming timeslots.

In addition, the endpoint router 506 can apply more intelligence to the service assurance utilizing various methods. For example, endpoint router 506 may utilize a make-before-break strategy for establishing communications with satellite communication networks. This may include ensuring the data communication channel with the secondary satellite communication network 306 is stable before making a routing change from the connection to the primary satellite communication network 308.

Further, the endpoint router 506 may perform application performance verification. This can involve assessing and/or confirming the performance of applications or software to make sure that they are functioning as expected and/or meeting certain performance criteria. This may be accomplished by continually running application-performance probes across all satellite communication network satellite constellations (e.g., primary satellite communication network 308 and secondary satellite communication network 306). This information may also be used to selectively route applications across both satellite communication network constellations similar to software-defined WAN approaches.

Furthermore, the endpoint router 506 may assess RF performance issues. For example, endpoint router 506 may run a ‘constellation status’ protocol between the endpoint router 506 and one or more satellite of the satellite communication networks, such that RF performance issues can be advertised to the endpoint router 506 to provide air-interface status costs to particular routes.

A router forwarding table may typically hold one path per destination, with additional layers of protocols to provide alternatives. However, in the presently described implementations include the dimension of time since this is intrinsic to the expected position of the vehicle 304 with respect to the satellite communications paths. As such, endpoint router 506 may have either an additional layer of calculations based on time, or a significant change to the routing table such that the dimension of time is considered. Carrying routes in groups through tagging or grouping using next-hops may be used to apply a time-series route map to more than one route. In this manner, a single time-series can be held within the router for the group, instead of one per prefix or application, however traffic is classified and selected for routing decisions.

Whether utilizing the digital twin strategy or others, continual assessment of data variables may be performed to monitor for changes and/or provide updates (e.g., updated communication schedule 512) via a push mechanism which is forwarded through a filtering mechanism to only catch interesting information that could possibly affect the decision-making process on the endpoint router 506 or in the network. As such, a feedback loop may be utilized that can automatically update time-series schedules for the endpoint router 506 responsive to changes in the data.

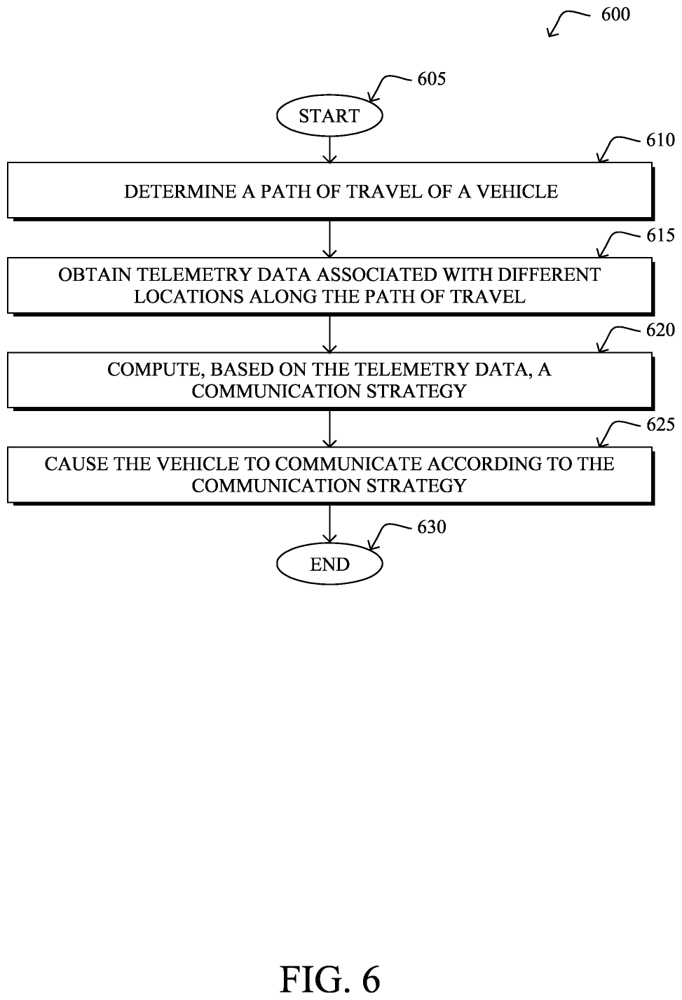

FIG. 6 illustrates an example simplified procedure (e.g., a method) for the computation of communication strategies between an endpoint and multiple satellite communications networks, in accordance with one or more implementations described herein. For example, a non-generic, specifically configured device (e.g., device 200), may perform procedure 600 by executing stored instructions (e.g., communication strategy computation process 248).

The procedure 600 may start at step 605, and continues to step 610, where, as described in greater detail above, a path of travel of a vehicle may be determined. The vehicle may be an aircraft or another type of vehicle. The vehicle may include an endpoint router that is capable of communicating across multiple satellite communication networks. The path of the vehicle may be determined based shipping routing, journey plans, and/or live traffic data for the vehicle. In addition, the path of the vehicle may be determined based on air-traffic control data and/or a flight plan for the vehicle.

At step 615, as detailed above, telemetry data associated with different locations along the path of travel may be obtained. The telemetry data may include satellite constellation orbit data for the primary satellite network and the secondary satellite network, topographic data of terrain associated with the path of the vehicle, includes earth weather data associated with the path of the vehicle, space weather data, includes Internet performance data, and/or includes non-terrestrial network performance data.

In various implementations, application performance probes may be run across the primary satellite network and the secondary satellite network to collect the telemetry data. The telemetry data may include advertised radio frequency (RF) performance data resulting from execution of a constellation status protocol between a router on the vehicle and each of the primary satellite network and the secondary satellite network.

At step 620, as detailed above, a communication strategy may be computed based on the telemetry data. The communication strategy may be computed such that the vehicle switches from using a first transceiver to communicate with a primary satellite network and a second transceiver to communicate with a secondary satellite network. In various implementations, computation of the communication strategy may be configured to retain data communicated from the vehicle within geographical boundaries throughout its communication to its destination.

In some examples, the computation may include utilizing a digital twin to repeatedly model updated communication strategies based on updated telemetry data. Once an updated communication strategy is computed, it may be communicated as the communication strategy to a router of the vehicle.

At step 625, as detailed above, the vehicle may be caused to communicate according to the communication strategy. This may include causing the primary satellite network to communicate data to the secondary satellite network according to the communication strategy. That is, inter-satellite communication network communication links may be established and/or utilized based on the communication strategy. In various implementation, it may first be confirmed that a connection from the second transceiver to the secondary satellite network is stable before switching from using the first transceiver to communicate with the primary satellite network to using the second transceiver.

Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, introduce a mechanism to facilitate resilient global data communication by computing and implementing communication strategies that facilitate communication across multiple satellite communication networks. Not only do the techniques incorporate real time data to compute communication strategies in a dynamic manner that accounts for and adapts to conditions influencing communication performance across the satellite communication network, but they also introduce mechanisms of communication boundary enforcement. Therefore, data can be communicated in a manner that is optimized to satellite communication network conditions, leverages multiple satellite communication networks, and still honors data sovereignty requirements. As a result, satellite communication networks and/or the applications and hardware they support will have improved function by virtue of the increased network coverage and resiliency while reliably operating within data sovereignty requirements.

While there have been shown and described illustrative implementations that provide computation of communication strategies among satellite communication networks, it is to be understood that various other adaptations and modifications may be made within the spirit and scope of the implementations herein. For example, while certain implementations are described herein with respect to using the techniques herein for certain purposes, the techniques herein may be applicable to any number of other use cases, as well. In addition, while certain types of vehicles, devices, and/or groupings of devices are discussed herein, the techniques herein may be used in conjunction with any devices and/or groupings of devices.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
determining, by a device, a path of travel of a vehicle;
obtaining, by the device, telemetry data associated with different locations along the path of travel;
computing, by the device and based on the telemetry data, a communication strategy whereby the vehicle switches from using a first transceiver to communicate with a primary satellite network and a second transceiver to communicate with a secondary satellite network; and
causing, by the device, the vehicle to communicate according to the communication strategy.

2. The method as in claim 1, wherein the telemetry data includes satellite constellation orbit data for the primary satellite network and the secondary satellite network.

3. The method as in claim 1, wherein the telemetry data includes topographic data of terrain associated with the path of the vehicle.

4. The method as in claim 1, wherein the telemetry data includes earth weather data associated with the path of the vehicle.

5. The method as in claim 1, wherein the telemetry data includes space weather data.

6. The method as in claim 1, wherein the telemetry data includes Internet performance data.

7. The method as in claim 1, wherein the telemetry data includes non-terrestrial network performance data.

8. The method as in claim 1, wherein the path of the vehicle is determined based on at least one of shipping routing, journey plans, or live traffic data for the vehicle.

9. The method as in claim 1, wherein the path of the vehicle is determined based on at least one of air-traffic control data or a flight plan for the vehicle.

10. The method as in claim 1, further comprising:
confirming that a connection from the second transceiver to the secondary satellite network is stable before switching from using the first transceiver to communicate with the primary satellite network to using the second transceiver.

11. The method as in claim 1, further comprising:
running application performance probes across the primary satellite network and the secondary satellite network to collect the telemetry data.

12. The method as in claim 1, wherein the telemetry data includes advertised radio frequency (RF) performance data resulting from execution of a constellation status protocol between a router on the vehicle and each of the primary satellite network and the secondary satellite network.

13. The method of claim 1, further comprising:
utilizing a digital twin to repeatedly model updated communication strategies based on updated telemetry data; and
communicating an updated communication strategy as the communication strategy to a router of the vehicle.

14. The method of claim 1, further comprising:
causing the primary satellite network to communicate data to the secondary satellite network according to the communication strategy.

15. A tangible, non-transitory, computer-readable medium having computer-executable instructions stored thereon that, when executed by a processor on a computer, cause the computer to perform a method comprising:
determining a path of travel of a vehicle;
obtaining telemetry data associated with different locations along the path of travel;
computing, based on the telemetry data, a communication strategy whereby the vehicle switches from using a first transceiver to communicate with a primary satellite network and a second transceiver to communicate with a secondary satellite network; and
causing the vehicle to communicate according to the communication strategy.

16. The tangible, non-transitory, computer-readable medium as in claim 15, further comprising instructions executable to cause the computer to perform the method comprising:
configuring computation of the communication strategy to retain data communicated from the vehicle within geographical boundaries throughout its communication to its destination.

17. The tangible, non-transitory, computer-readable medium as in claim 15, further comprising instructions executable to cause the computer to perform the method comprising:
confirming that a connection from the second transceiver to the secondary satellite network is stable before switching from using the first transceiver to communicate with the primary satellite network to using the second transceiver.

18. The tangible, non-transitory, computer-readable medium as in claim 15, further comprising instructions executable to cause the computer to perform the method comprising:
utilizing a digital twin to repeatedly model updated communication strategies based on updated telemetry data; and
communicating an updated communication strategy as the communication strategy to a router of the vehicle.

19. The tangible, non-transitory, computer-readable medium as in claim 15, further comprising instructions executable to cause the computer to perform the method comprising:
causing the primary satellite network to communicate data to the secondary satellite network according to the communication strategy.

20. An apparatus, comprising:
one or more network interfaces to communicate with a network;
a processor coupled to the one or more network interfaces and configured to execute one or more processes; and
a memory configured to store a process that is executable by the processor, the process, when executed, configured to:
determine a path of travel of a vehicle;
obtain telemetry data associated with different locations along the path of travel;
compute, based on the telemetry data, a communication strategy whereby the vehicle switches from using a first transceiver to communicate with a primary satellite network and a second transceiver to communicate with a secondary satellite network; and
cause the vehicle to communicate according to the communication strategy.
